(19) United States
(12) Patent Application Publication
(10) Pub. No.: US 2024/0419707 A1
(43) Pub. Date: Dec. 19, 2024

(54) ENABLING FEDERATED CONCEPT MAPS IN LOGICAL ARCHITECTURE OF DATA MESH

(71) Applicant: Telefonaktiebolaget LM Ericsson (publ), Stockholm (SE)

(72) Inventors: Perepu SATHEESH KUMAR, Chennai (IN); Saravanan M, Chennai (IN)

(73) Assignee: Telefonaktiebolaget LM Ericsson (publ), Stockholm (SE)

(21) Appl. No.: 18/718,998

(22) PCT Filed: Dec. 14, 2021
(86) PCT No.: PCT/IN2021/051169

§ 371 Date: Jun. 12, 2024

(51) Int. Cl. G06F 16/33

(52) U.S. Cl. CPC G06F 16/3346

(57) ABSTRACT

In one aspect, a method includes obtaining a first and second set of word embeddings from a first local machine learning (ML) model and a second local ML model. The method includes generating first and second latent space representations by processing the first and second sets of word embeddings using an artificial neural network (ANN) trained with the first and second local ML models, wherein the first and second latent space representations comprises a plurality of first and second contexts associated with the first and second set of word embeddings. The method includes correlating the first and second sets of word embeddings based on the plurality of first and second contexts. The method includes aggregating, based on the correlating, the first set of word embeddings and the second set of word embeddings into a global Machine Learning (ML) model of word embeddings.

### TECHNICAL FIELD

Disclosed are embodiments related to federated learning for use in natural language processing and search applications across different sets of documents.

### INTRODUCTION

One objective of a data mesh is to create a foundation for getting value from analytical data and historical facts at scale. There may be several variables at scale, including constant change in the data landscape, proliferation of both sources of data and consumers, diversity of transformation and processing that use cases require, and speed of response to change. A data mesh, at its core, is founded in decentralization and distribution of responsibility to people who are closest to the data in order to support continuous change and scalability. A data mesh follows the seams of organizational units as the axis of decomposition. To promote such decomposition, one typically needs to model a logical architecture that arranges the analytical data by domains.

FIG. 1 illustrates a logical data architecture. In this architecture, the domain's 102 interface to the rest of the organization not only includes the operational capabilities 106 but also access to the analytical data that the domain serves 104. Naturally, each domain 102 can have dependencies to other domains' operational and analytical data endpoints. Operational capabilities 106 reflect an operational capability or an operational data access provided and owned by the domain 102. Domain analytic data 104 includes analytical data provided and owned by the domain 102. Such dependencies may be captured through a relationship mapping, such as a concept map, as a first step for a specific user.

The other challenges of existing analytical data architectures are the high friction and cost of discovering, understanding, trusting, and ultimately using quality data. If not addressed, this problem only exacerbates with a data mesh, as the number of places and teams who provide data—i.e., the domains—increases. For example, a telecommunications company may handle many operator networks and can generate lot of operator data, and these operators may not want to share information across different operators due to privacy concerns. In order to handle tasks by field service operators, there may sometimes be a need to transfer data from the operators, but these operators will not agree to such a data transfer. Federal learning approaches are one mechanism to address data and trust in the decentralization process because such decentralized federated learning may preserve model and data privacy.

Architecturally, to support data as a product that domains can autonomously serve or consume, a data mesh introduces the concept of a data product as its architectural quantum. Architectural quantum, as defined by evolutionary architecture, is the smallest unit of architecture that can be independently deployed with high functional cohesion and includes all the structural elements required for its function. Once mechanism to achieve this process is by sending relationship mappings, e.g., concept maps, as structural elements as a model parameter to a global model in the decentralized federated approach.

To achieve this basic objective, one has to follow the four underpinning principles that any data mesh implementation embodies to achieve the promise of scale, while delivering quality and integrity guarantees needed to make data usable: 1) domain-oriented decentralized data ownership and architecture, 2) data as a product, 3) self-serve data infrastructure as a platform, and 4) federated computational governance.

### SUMMARY

There are a number of challenges in developing a model that considers all four principles in order to, for example, enable a data mesh objective in a large telecom network. One of the major issues in the telecom network area is the lack of access to adequately labeled data, which is primarily due to legal protection regulations and/or industrial confidentiality. Methods to mitigate these issues come from the area of federated learning where no direct access to training data is required. Original federated learning approaches utilize a central instance to perform Machine Learning (ML) model synchronization by periodically aggregating all model parameters. However, there are many scenarios where trained ML models cannot be published since they either include confidential knowledge or training data could be reconstructed from them. Furthermore, the central instance needs to be trusted and is a single point of failure such that if the central instance fails or is corrupted the entire system will cease to work.

As a solution, some of the embodiments disclosed herein propose a fully decentralized approach that allows knowledge to be shared between trained models. Neither original training data nor model parameters need to be transmitted. Accordingly, a decentralized federated learning approach [1] is proposed that includes sending domain-specific concept visualizations as model parameters to build a local as well as global ML model. Here cognitive visualization encompasses a role in transferring the knowledge without full details by maintaining ML model and data privacy.

Cognitive visualizations are tools that make “thinking” visible, reifying learners' mental model about domain knowledge onto an explicit graphical device. They make possible the application of “cognitive apprenticeship” approaches like reflection and scaffolding [2]. Reflection can be supported by confronting the learner with a different visualization of his/her own knowledge, while scaffolding can be implemented by contrasting the learners' visualization to that of an expert. One cognitive visualization technique is Concept Mapping. Concept Maps (CM) represent a person's understanding of a topic by mapping concepts and their relationships in a hierarchical way, where more general concepts are placed higher in the map and concepts at the same level of generalization are grouped together. There is extensive evidence that drawing a CM requires sufficient knowledge to engage in higher cognitive functions [3].

In [4], the authors discussed various challenges who can encounter in the usage of federated learning for natural language processing (NLP) applications. One such challenge addressed herein is the usage of relationship mapping, including CMs, in federated learning.

In [5], the authors proposed how concept maps across users can be combined and can be used to fill missing nodes in the concept maps. Here the concept maps can expand with time whenever the user adds new data points to it. The main assumption is that all users have similar documents belonging of a particular context. However, in the real world each user can have different contexts and hence this method cannot be used effectively.

In some networks, there may be a Consumer Price Index (CPI) store where all problems and solutions relating to different operators may be stored, although the products are the same or similar. Due to privacy aspects, one operator issue may not be disclosed outside to other operators, and accordingly it may be difficult to share a specific solution to a future system operator (FSO) without revealing operators' sensitive information. According to some embodiments, the platform and methodology discloses herein addresses the privacy issues while solving solve huge customer service issues today.

Usually, data in the form of documents is stored in different places, but due to privacy regulations, documents cannot be sent across the different place. Since entities still need to include all of these documents in order to provide accurate search results across the organization, traditional search results using concept maps may violate data storage guidelines and lead to privacy concerns.

According to some of the embodiments disclosed here, a federated learning setting is used to combine information across different set of documents available at different places. There are a few issues with the usage of federated learning setting for NLP settings.

First, relationship maps possess underlying information on the documents. Hence relationship maps must first be converted to numeric vectors and used in the federated learning setting.

Second, every relationship map has different set of numeric vectors, which are obtained as per local context. Hence, merging them together in the global user may lead to poor results.

Third, since the global model will have to sort out many different contexts relate to the user queries, information must be provided identifying the context of the user.

Fourth, since the relationship map contains sensitive data, the relationship map should be encoded into latent space which is different for each user and additional information is necessary to preserve the properties of concept map.

According to aspects disclosed herein, the above four issues are addressed in order to use federated learning in a search application. Relationship maps are converted to embeddings vectors based on the entities and their relations. Before sending the relationship maps to a global ML model, the relationship maps are converted to a latent space by using an artificial neural network (ANN). The network is trained along with the local embedding ML model to preserve the contents of relationship map embeddings in original space and latent space. Further, the global model is trained to merge these embeddings based on the context of the document. Finally, when the user searches for a query, the context of the query is identified and results are output.

According to some aspects, a method combines the relationship maps in a federated learning setting. A neural network model may be trained with an embedding ML model to preserve the privacy of the users. One advantage of the proposed approach is preserving data privacy across different locations since data is not been shared. Also, since features of other operator data are used, a good ML model can be achieved with high accuracy that can help FSO's (irrespective of any operator data) to solve the problem.

In one aspect, a computer-implemented method for searching a plurality of data sources is provided. The method includes obtaining, from a first local ML model, a first set of word embeddings corresponding to a first relationship mapping of a first plurality of documents from a first data source. The method includes obtaining, from a second local ML model, a second set of word embeddings corresponding to a second relationship mapping of a second plurality of documents from a second data source. The method includes generating a first latent space representation by processing the first set of word embeddings using a first artificial neural network (ANN) trained with the first local ML model, wherein the first latent space representation comprises a plurality of first contexts associated with the first set of word embeddings. The method includes generating a second latent space representation by processing the second set of word embeddings using a second ANN trained with the second local ML model, wherein the second latent space representation comprises a plurality of second contexts associated with the second set of word embeddings. The method includes correlating the first set of word embeddings and the second set of word embeddings based on the plurality of first contexts and the plurality of second contexts. The method includes aggregating, based on the correlating, the first set of word embeddings and the second set of word embeddings into a global ML model of word embeddings. The method includes obtaining a search query, the search query comprising a context and one or more word embeddings. The method includes generating a response to the query using the global ML model. The method includes outputting the generated response to a user.

In another aspect there is provided a computing device adapted to perform the method. In another aspect there is provided a computer program comprising instructions which when executed by processing circuitry of a computing device causes the device to perform the method. In another aspect there is provided a carrier containing the computer program, where the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a logical data architecture.

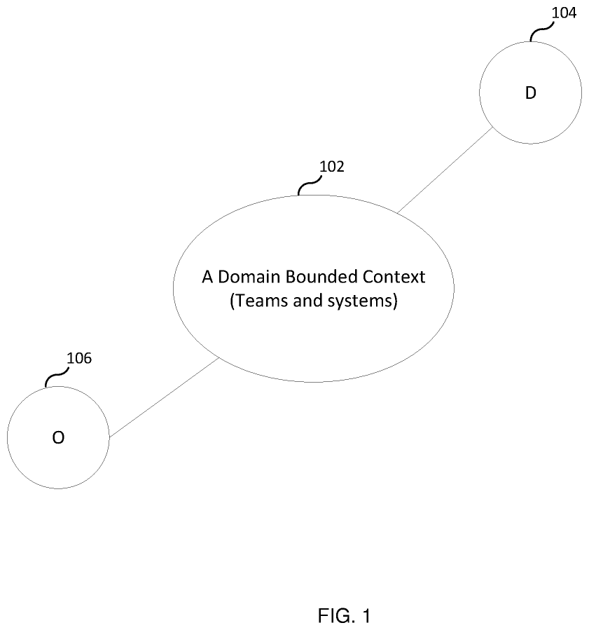

FIG. 2 illustrates an example concept map, according to some embodiments.

FIG. 3 illustrates an example parts of speech tagger, according to some embodiments.

FIG. 4 is a flow diagram, according to some embodiments.

FIG. 5 is a sequence diagram, according to some embodiments.

FIG. 6 illustrates a method, according to some embodiments.

FIG. 7 is a block diagram of a computing device according to some embodiments.

### DETAILED DESCRIPTION

Centrally storing data is common practice among industries. However due to privacy reasons, this is not always feasible, and data should be stored at local places (i.e. local computing devices) instead of a central place (i.e., central computing device). Embodiments disclosed herein use distributed ML techniques, such as federated learning (FL) techniques, to transfer the insights of the local data from the local computing devices to a global computing device. However, there are limited approaches to handling natural language processing (NLP) ML models, including concept maps and knowledge graphs, in the case of federated learning.

Techniques are disclosed herein to transfer relationship maps generated at local computing devices of the same or different operators and combine them in a global computing device using the contextual information on the local computing devices. Further, mechanisms are disclosed to enable a user to search the global computing device in order to obtain an optimal solution and search result.

To preserve the privacy of the local computing devices, an artificial neural network model is added before an embedding ML model. The artificial neural network model ensures that the relationship map is transformed into latent space. To further preserve the properties of embeddings obtained from the relationship map, the artificial neural network is trained together with the embedding ML model. Since every local computing device will have different latent space representations to represent their own context, each operator cannot interpret information from other operators, and thereby privacy can be ensured.

The embodiments and techniques disclosed herein may provide a number of technical advantages over prior FL and NLP solutions. For example, the proposed approach can be used to preserve privacy of data without transferring the data to a central location, i.e., central computing device. The proposed approach can result in obtaining a good accurate ML model without transferring the actual data. The proposed approach can help to minimize the central storage space needed for storing the data since the data is stored at local computing devices. The approach embeds the principles of a data mesh, such as 1) domain-oriented decentralized data ownership and architecture, 2) data as a product, 3) self-serve data infrastructure as a platform, and 4) federated computational governance.

For illustrative purposes, assume there are N users in an organization, and each user corresponds to a different geographical place. To build a search tool, relationship maps may be constructed from the documents and used to address queries posted by users.

A relationship map may be similar to a knowledge graph where the nodes represent the important words in the domain. For example, in social media application, the nodes may represent game names, places, etc. Any two nodes in the relationship map are connected with a directed graph. In the case of a knowledge graph, the nodes are connected with an edge that has some description to it, called a relationship. Accordingly, the relationship map is represented by set of tuples (<E₁, E₂, R>), where E₁, E₂ are the entities (e.g., nodes) and R is the relation between these entities. These tuples are extracted from a set of documents and are stored in a database. When the user enters a query, the database of tuples is searched in order to obtain results to the query.

Since there may be data restrictions in place, the relationship map itself may not be able to be sent to the global search engine i.e., global computing device. Accordingly, aspects disclosed herein use a FL approach that consumes anonymized relationship maps from local computing devices in order to arrive at a global search engine i.e., global computing device. Because these local relationship maps can have different contexts, the local relationship maps cannot be merged in the same way they may be done just for like normal FL. Instead, the local relationship maps may need to be merged based on the context of the relationship maps identified from a global ML model.

The techniques disclosed herein include three steps. First, relationship maps are sent from local computing devices to a global ML model in the global computing device. Second, the local relationship maps are merged into a global ML model based on context. Third, a search query is interpreted and processed using the global ML model. These steps are described in further detail below.

Sending Relationship Maps Embeddings from Local Computing Devices to Global ML Model in the Global Computing Device.

Initially, all the relationship maps from the local computing devices are collected and merged in the global computing device. Since the local relationship maps have information related to specific documents, the local relationship maps may not be able to be sent to the global computing device as-is. Hence, the local relationship maps may need to be anonymized first by generating embeddings, which may be generated using the following approach.

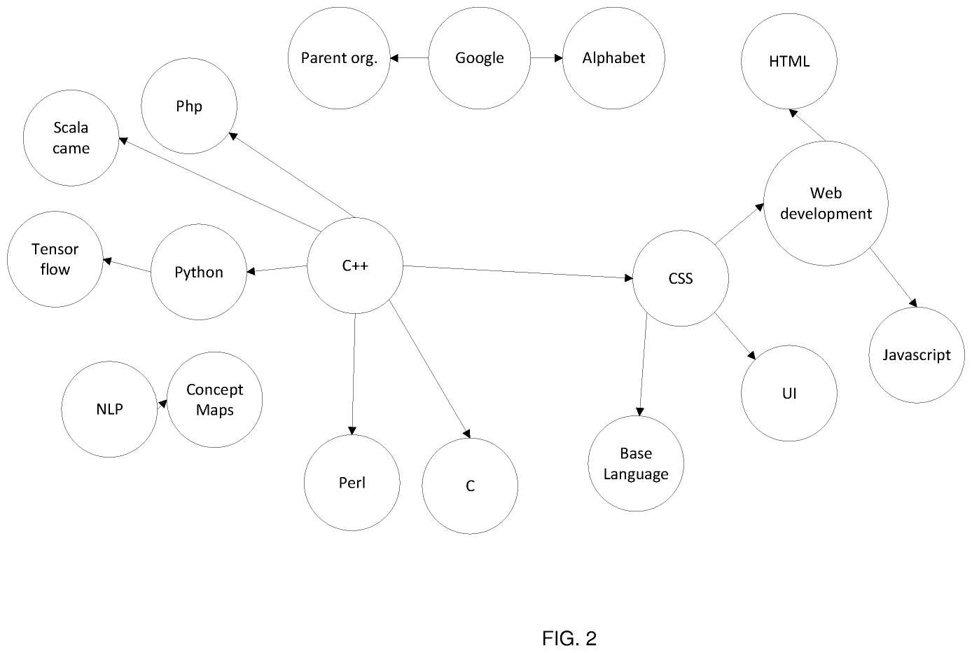

FIG. 2 illustrates an example concept map, according to some embodiments. In some embodiments, a relationship map may refer to a concept map. The concept map is constructed using the following approach. In some embodiments, Rapid Automatic Keyword Extraction (RAKE) is used to return all of the keywords present in a selected document. Next, an appropriate Parts of Speech (POS) tagger may be used to automatically categorize the extracted keywords into pairs of two entities.

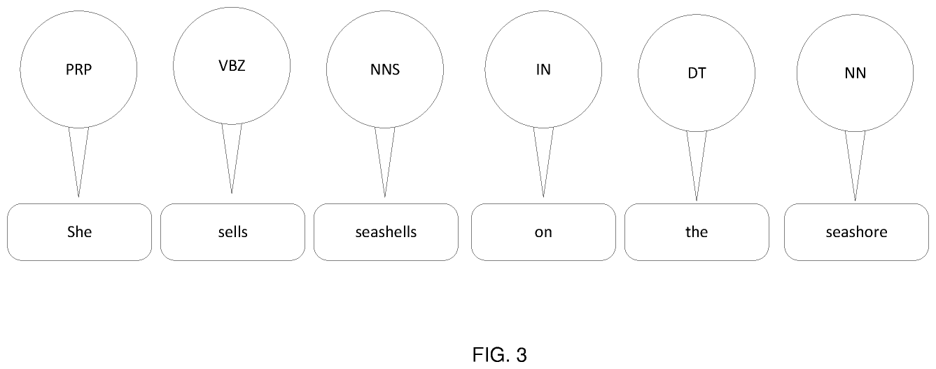

FIG. 3 illustrates an example POS tagger, according to some embodiments. The same process is repeated for every sentence. The pairs of entities are taken, and parent-child annotation is given after checking their dominance ratio. After creating the repository of parent-child annotations for entities, a Depth First Search (DFS) algorithm is used in order to bring out all the parent and child nodes for a given input query. The knowledge repository can be updated on a daily basis by feeding more documents to the program. Updating the repository generalizes and improves the repository, and helps to output more relevant words.

At the conclusion, a concept map is obtained as shown in FIG. 2. The concept map consists of many tuples, and relationships between the tuples.

Next, all the tuples (<E₁, E₂, R₁>) of all the documents for a particular local computing device are collected. A local ML model is trained that will take entities and predict the relation between the entities for the local computing device. For example, it will construct the table as shown in Table 1 below using following data. In some embodiments, the local ML model is an embedding model.

TABLE 1

| Serial Number | Entities | Relation |
|---|---|---|
| 1 | E₁, E₂ | R₁ |
| 2 | E₃, E₄ | R₂ |
| 3 | E₂, E₃ | R₂ |

The data is passed to a fully connected layer of the local embedding ML model that will take the entities as input and the relation as the output. This process is similar to a Continuous Bag of Words (CBOW) model, which is used to estimate the word embeddings. Once the word embeddings are computed, the word embeddings are sent to the global computing device.

For each local computing device participating in the FL setting, the above approached is used to compute the relationship map embeddings. Each local computing device will send a dictionary of embeddings along with its embedding value to the global computing device. The expected output is {′E₁:vector,E₂:vector,E₃:vector,E₄:vector,R₁:vector, R₂:vector}. These dictionaries are for a single local computing device, and these dictionaries are created for all the N local computing devices.

Merging the Local Relationship Maps into Global Computing Device Based on Context

As described above, relationship map word embeddings are computed for the local computing device. The local computing device will send the embeddings, e.g. dictionaries, to the global computing device. In the global computing device space, there may be poor search results if the local embeddings are simply merged without underlying contexts. According to aspects of the present disclosure, the contexts of the embeddings are determined and used to merge the local embeddings at the global computing device.

One issue is that there may be only be a small amount of words, and identifying contexts from these set of words may be impossible. Accordingly, a pre-trained ML model such as a Bidrectional Encoder Representations from Transformers (BERT) model may be used to identify the context based on the set of words.

Accordingly, the set of word embeddings from the same local computing device may be used to identify the context of those word embeddings. The identified context of the word embeddings may then be used to merge them in the global computing device. The merging may be performed as follows.

First, if local computing devices' contexts are similar, then the local word embeddings may be combined by computing an average for a given word embedding.

Second, if local computing devices' contexts are not similar, then the local computing devices' embeddings may be maintained and used it to obtain the embeddings for a given search query.

Third, in scenarios where there is poor data in a local computing device or node, there may be a poor global update on the global ML model. To avoid this, categorization techniques may be employed to prevent such poor global ML model updates, including those described in international application publication number WO20211199052. For example, a Latent Dirichlet Allocation (LDA) model may be employed to identify topics in documents, where the loss function of the LDA model is used for finding a distribution of words associated with each topic. A categorizer, such as a classifier, may further be used to categorize documents. In order to compensate for poor data, the loss function (e.g., objective function) of the LDA model may be modified by adding the loss function of the categorizer (e.g., the classifier) to the loss function of the LDA model.

There may be problems, however, when the remote user of a local computing device is querying if there are multiple contexts in the user space. Accordingly, in some embodiments, the aggregation of the word embeddings can also be done on a problem level. In such embodiments, the upper element of dictionary may contain a problem name and elements corresponding to it.

These merging techniques are against traditional FL techniques where words are combined in terms of embeddings without any context applied to the combination. However, since there may be different contexts in NLP applications, traditional FL techniques may result in poor performance if traditional averaging if performed. Accordingly, certain embodiments disclosed herein use the type of merging and averaging discussed above.

At the end of the merging step, there will be a dictionary of dictionaries (metadata). The upper dictionary contains labels corresponding to the context of the word embeddings. The lower dictionaries correspond to the embeddings obtained from the merging the local computing devices. For example, the upper level dictionary output obtained at this step may encompass: {‘Context:’RAN’:{‘E₁:vector,E₂:vector,E₃:vector,E₄:vector,R₁:vector, R₂:vector},‘Applications’ :{‘E₁:vector,E₂:vector,E₃:vector,E₄:vector,R₁:vector, R₂:vector} }, etc.

Since contexts are shared across the different local computing devices here, a good accurate global ML model may result. For example, if there is one local computing devices with a missing context, the global ML model can be used for users of the computing devices who have missing contexts because it contains all the different contexts. Accordingly, queries can be searched even where some contexts are not present in operator's data. It should be appreciated that all the keywords may not necessarily be present in all the contexts.

### Understanding Search Query and Use the Corresponding Context Global ML Model

Training the search ML model: First a public dataset is obtained that contains a collection of queries and corresponding search results. For each query in the public dataset, the active words in the output are identified. Based on the active words in the output, the conditional probabilities of each and every word in the global ML model with respect to the context of the search query will be marked. The context of the search query may be necessary since the predicted search query context may be different from that of an original context.

Next, conditional probabilities are computed for each and every word and then updated against the context of the search query and the contents of the search query.

Finally, the global ML model is trained with the following components.

A. For a given query, the context of the query is identified using the pre-trained BERT model.

B. For the identified context and words in the query, the conditional probabilities are computed based on answers in the private datasets from the local computing devices.

C. The global ML model is trained with the context and search embeddings as input, and the conditional probabilities against each word as output.

As an example, the private dataset may look like what is shown below in Table 2.

TABLE 2

| Question | Answer |
|---|---|
| Who is president of U.S.A | Joe Biden |
| What is capital of U.S.A | Washington |

In some embodiments, the embeddings are obtained from FL and are used as input features for the network. The context of each question is may be collected using the BERT model, and the embeddings of answers are also collected and used to compute conditional probabilities of the answers. The global ML model may be trained using the following approach.

For example, a long short-term memory (LSTM) model or a fully connected network may be trained with these input features and output probabilities. This training technique tends to use soft label values rather than hard labels, which may result in good output accuracy.

When a remote user of a remote computing device inputs a search query, the system will first use the pre-trained BERT model to identify the context of the query. Further, using the context and search word embeddings as input to train global ML model, the conditional probabilities of each word are predicted in the output. Finally, the words in the output are collected and arranged in grammatical way using natural language generation (NLG) techniques in order to arrive at a search result for the query input by the user of the remote computing device.

For a given search query, the training data may look like what appears in Table 3, below.

TABLE 3

| Features | Output |
|---|---|
| [s1: embedding, s2: | [w1: No. of times present in the text |
| embedding, . . . ] | w2: No. of times present in the text, . . . ] |

Table 3 includes s1 and s2, which are words present in the search query and corresponding embeddings, and w1 and w2, which are output words with corresponding conditional probabilities. For each of the queries present in the private dataset, the data may be marked in accordance with the above format and used to train the global ML model.

In some embodiments, the global ML model is chosen as an encoder-decoder model. The encoder may consist of each word replaced with embeddings in the text. The decoder may consist of the conditional probabilities used against each word present in the text. Since there is a different number of words present in the output, a decoder approach may be used to train the model.

The testing data may consist of what appears in Table 4, below.

TABLE 4

| Features | Predicted Output |
|---|---|
| [s1: embedding, s2: embedding, . . . ] | [w1: p1, w2: p2, . . . ] |

The values of p1 and p2 are output from the global ML model trained using the previous training dataset. From the words present in the output, NLG techniques are used to arrive at the answer.

In some embodiments, the NLG summary output contains only the abstract text, which can help FSOs to solve the document. This abstract solution might be enough for experienced FSOs. But newer FSOs or persons who do not have extensive knowledge in a certain area may need more information. Accordingly, in some embodiments, the document may be extracted, the contents may be anonymized, and the anonymized document may be presented to the end user of the remote computing device. In some embodiments, the administrator may mark some of the words in the documents as anonymized as they reveal sensitive or confidential information about the underlying data. Next, the system can identify the words that may be present in the query using the global ML model, and see which document has the greatest number of words. Further, the words that are marked as anonymized may be removed and the anonymized document may be given to the user of the remote computing device. In this way, the anonymized document may be provided to the FSO, who can use such information to solve a problem.

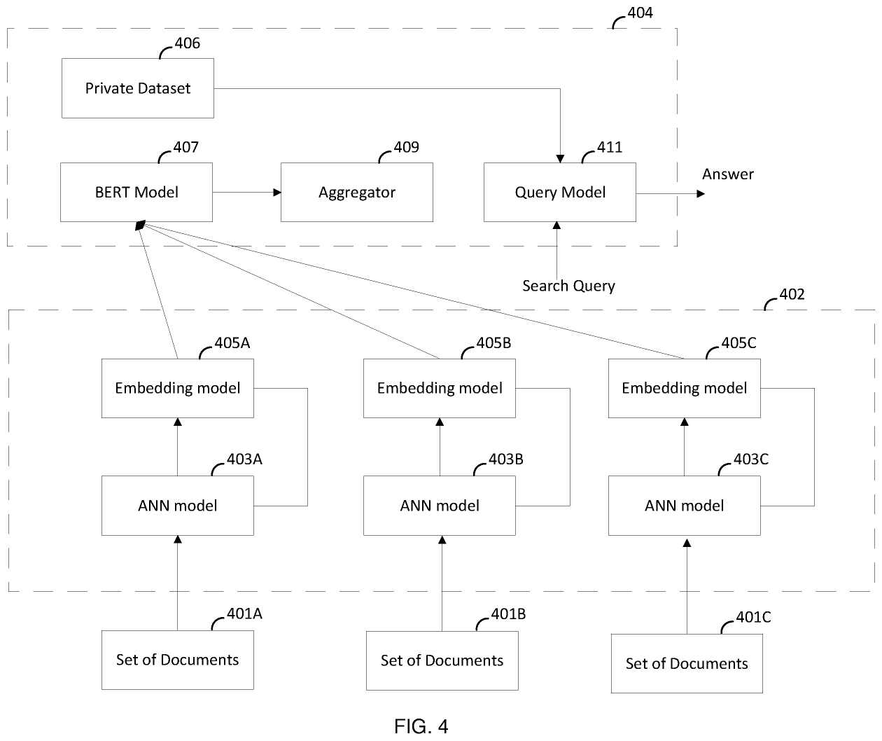

FIG. 4 is a flow diagram, according to some embodiments. FIG. 4 illustrates the flow of information through the architecture of the system. While difficult, it may not be impossible to estimate the content of the operators based on the information of the embeddings. To prevent such estimation, an artificial neural network (ANN) model is added before the embedding ML model at the local computing device 402.

At 401A-C, words are extracted from the sets of documents at local computing devices and relationship maps are constructed from each of the documents.

At 403A-C, the documents are sent to the ANN model. The ANN model converts the set of documents in latent space where in order to obtain latent space words.

At 405A-C, the embedding ML model computes the embeddings based on the latent space output from the ANN.

According to some embodiments, the ANN model will convert the embeddings in latent space. To make sure the latent space embeddings and normal embeddings are the same, the ANN and embedding ML model may be trained together. In this way, the privacy of the user of the local computing device may be preserved and it will be very difficult to construct the data of the local computing devices. For example, since information from users of multiple local computing device will be different across different local computing device user, it is extremely difficult to construct the original embeddings even when there is overlap of information.

At 407, the resulting relationship map embeddings may be sent to a BERT model at the global computing device 404.

At 409, the relationship map embeddings are aggregated according to the techniques disclosed above. In addition, at 411, the query ML model may be trained using a public dataset as well as a private dataset 406 as described above.

### Illustrative Example

In one example, the system may be used with the available CPI product store at a telecommunications company that has many products originating from different geographical areas. Due to data restrictions, such as the General Data Protection Regulation (GDPR), sometimes the data stored at one geographical location cannot be sent to other regions even if the users at other places need to use the data in order to help arrive at a solution. Accordingly, in this scenario there is a large data mesh where there are multiple data points stored in large amounts of data.

Moreover, searching may be faster when the data is stored at single place rather than multiple places. When the data is stored at multiple places, users often need to spend significant time waiting for search results, and the remote data storage may lead to privacy concerns. Accordingly, a federated learning approach may be used in order to come up with global relationship map data useful for searching.

In this example, documents were collected corresponding to LTE RAN products from the CPI store. In the CPI store there are three underlying sub-libraries for Radio, RAN and other products. These individual libraries are treated as different local users stored at different places. In addition, a public dataset of 10 questions and answers was collected and used to develop a federated relationship map.

Documents were extracted for each set of local users of the local computing devices, and the relationship map was estimated for each of the local users of the local computing devices based on the documents. Next, the embeddings for the set of words in the relationship map were calculated using the method discussed above, resulting in N dictionaries for each local user of the local computing device.

A sample concept map was generated at a local user of the local computing device. The context identified for the user of the local computing device was RAN. The top node contained the document information on the type of document for the local user of the local computing device, and connections are keywords connected to the document. One keyword can have multiple connections to it, i.e., each parent can have multiple children and not the other way.

The sample concept map was converted to a dictionary as described above. Next, the latent space representation was determined as described above, outputting a relationship map in the latent space model. In some embodiments, the latent space output contains the embeddings of the output in the latent space. In order to make sure the properties of original words and latent space words are similar, the embeddings ML model and ANN model are trained together.

In the FL setting, the embeddings of the output in the latent space were merged at a global computing device as described above. If the local users of the local computing devices have the same context, the embeddings will be averaged, or else the embeddings generated by a single user of the local computing device will be maintained.

Next, the dataset of questions and answers were used to compute conditional probabilities of potential words in an answer for a given question and context. These datasets may be used to train the global ML model, and the global ML model may be used to predict the words present in the answer.

When the user searches for some query, a pre-trained BERT model may be used to identify the context of search query. Further the search query embeddings are sent to the global ML model trained in previous paragraph. Now, based on the output of the global ML model, words that are present in the sentence answer are identified.

Finally, NLG techniques are used to frame the answer from the words in order to obtain an answer for a search query.

The proposed techniques were tested and provided results in the following table, which were confirmed by a domain expert in the area.

TABLE 5

| Questions | Answers |
|---|---|
| What is the difference between power | 180 Watts for Micro and 80 Watts for Pico |
| consumption per frequency band between | |
| Micro and Pico base station? | |
| what is the carrier bandwidth in CDMA? | In CDMA, Code Division Multiple Access |
| | (CDMA) is used and each carrier is 1.25 Mhz. |
| How much Energy saved when we use one | Using one radio in each sector for two carriers |
| radio in each sector for two carrier compared | offer 20% energy savings compared to one |
| to one radio per carrier? | radio per carrier. |
| what is the total nominal output power with | 3 × 2 20 W means each of the cell carriers has a |
| configuration 3*2 with 20 W? | nominal output power of 20 W, the total |
| | nominal output power is 3 × 2 × 20 = 120 W |
| How much CDMA carrier supported by RBS | RBS 6000 can support up to six 1.25 MHz |
| 6000? | CDMA carriers simultaneously |
| Which type of RBS 6000 radios/RRUS | RBS 6000 radios supporting CDMA are |
| required to support CDMA? | RRUS 11 B25, RRUS 11 B26A, RRUS 11 B4, |
| | RRUS11B5, RUS 01 B4, RUS 01 B2 and |
| | RRUS 12 B5 |
| What is Radio Network Dimensioning? | Radio Network Dimensioning can save |
| | considerable energy by allowing an optimum |
| | selection of RBS configuration. Radio |
| | Network Dimensioning also provides a |
| | framework to understand how total downlink |
| | output power (and hence power consumption) |
| | depends upon traffic, coverage, interference |
| | and specific operating conditions. |
| What is the maximum power consumption of | Maximum power consumption of DUL 20 is |
| DUL 20 and DUS 40? | 85 W and DUS41 is 220 W |
| What are the output-power consumption | Please refer below table for answer −2.7 RBS |
| values per cell -carrier with different | 6201 with RUS 01, 2.8 RBS 6601 with RRUS |
| combinations of DUL/DUS AND RRUS | 11, 2.9 RBS 6601 with RRUS 12 |
| units? | |
| What is the purpose of the function Network | The purpose is to synchronize all nodes in a |
| Synchronization? | network to primary Reference Clock |

According to some embodiments, in addition to the answers provided to the FSO, a supporting engine was also created in order to provide relevant documents to the user. A dictionary of all the words identified in the global context was created, and an admin was asked to mark which words are anonymous. Based on the words present in the answer created from the NLG engine, the system identified which document is a closest match to the answer in terms of word frequency. Any anonymized words in the document were removed, and the anonymized document was provided to the user. In this way, privacy of the users of the local computing device was preserved and an efficient search engine i.e., a global search ML model was created using a FL approach.

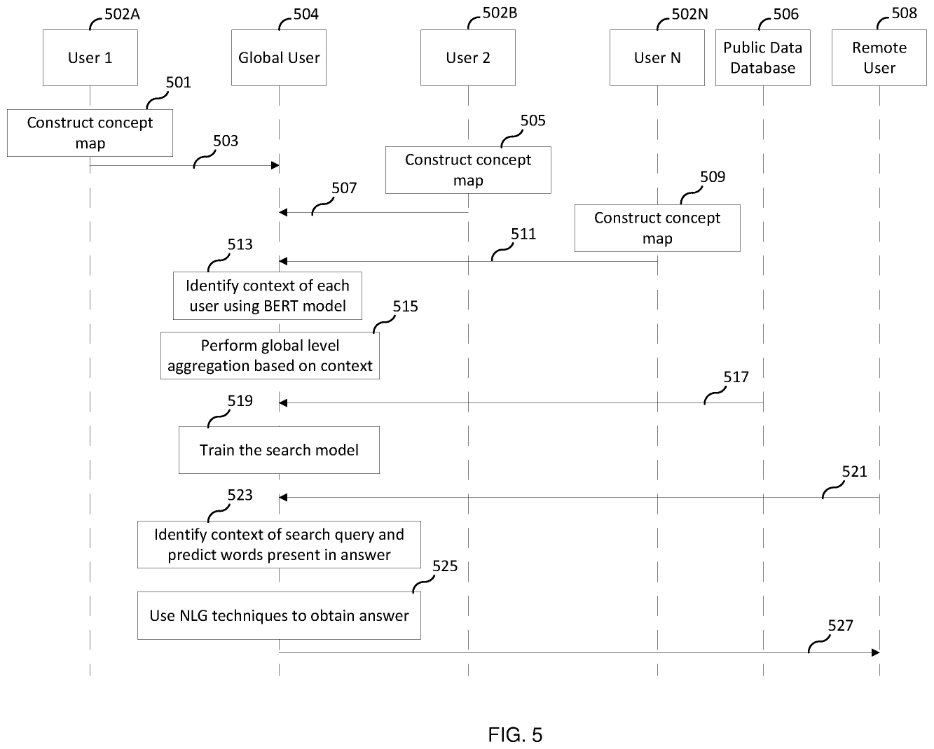

FIG. 5 is a sequence diagram, according to some embodiments. In some embodiments, FIG. 5 illustrates the flow of information among a global user or computing device 504, local users or computing devices 502A-N, a public data database 506, and a remote user 508.

At 501, local computing device 1 (502A) generates a concept map as described above, and at 503, the local computing device 1 transmits the local dictionary (e.g., embeddings and local context) to the global computing device 504. Similarly, at 505 and 509, local computing devices 2 through N (502B-N) created local concept maps, and at 507 and 511, the local computing devices transmit the local dictionary to the global computing device.

At 513, the global computing device identifies the context of each local computing device using a pre-trained BERT model as described above.

At 515, the global computing device 504 performs a global level aggregation based on the local contexts as described above.

At 517, a public dataset of questions and answers is provided to the global computing device 504, and used to train the search ML model at 519.

At 521, a remote user of the remote computing device 508 transmits a query to the global computing device 504.

At 523, the global computing device identifies the context of the search query and uses the global ML model to predict words present in an answer to the search query.

At 525, the global computing device uses NLG techniques to construct an answer to the query.

At 527, the global computing device transmits the answer to the query to the remote user of the remote computing device.

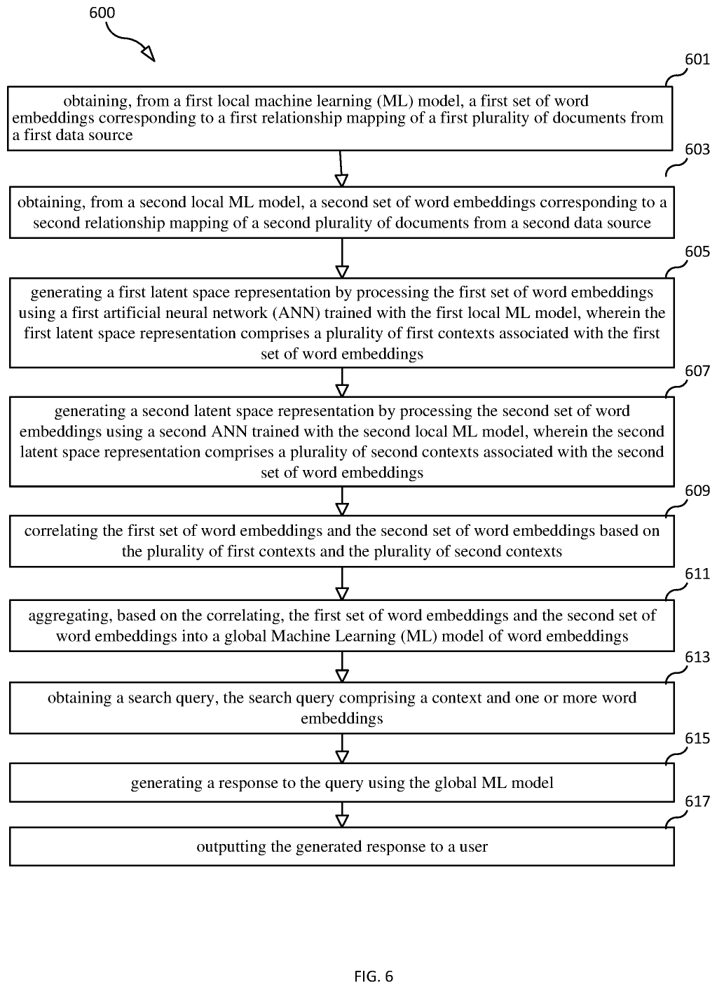

FIG. 6 illustrates a method, according to some embodiments. In some embodiments, method 600 is a computer-implemented method for searching over several data sources. In some embodiments, the data sources are located in disparate locations.

At step 601, the method includes obtaining, from a first local machine learning ML model, a first set of word embeddings corresponding to a first relationship mapping of a first plurality of documents from a first data source. In some embodiments, the first local ML model is an embedding ML model.

At step 603, the method includes obtaining, from a second local ML model, a second set of word embeddings corresponding to a second relationship mapping of a second plurality of documents from a second data source. In some embodiments, the second local ML model is an embedding ML model.

At step 605, the method includes generating a first latent space representation by processing the first set of word embeddings using a first artificial neural network (ANN) trained with the first local ML model, wherein the first latent space representation comprises a plurality of first contexts associated with the first set of word embeddings.

At step 607, the method includes generating a second latent space representation by processing the second set of word embeddings using a second ANN trained with the second local ML model, wherein the second latent space representation comprises a plurality of second contexts associated with the second set of word embeddings.

At step 609, the method includes correlating the first set of word embeddings and the second set of word embeddings based on the plurality of first contexts and the plurality of second contexts.

At step 611, the method includes aggregating, based on the correlating, the first set of word embeddings and the second set of word embeddings into a global ML model of word embeddings.

At step 613, the method includes obtaining a search query, the search query comprising a context and one or more word embeddings.

At step 615, the method includes generating a response to the query using the global ML model.

At step 617, the method includes outputting the generated response to a user.

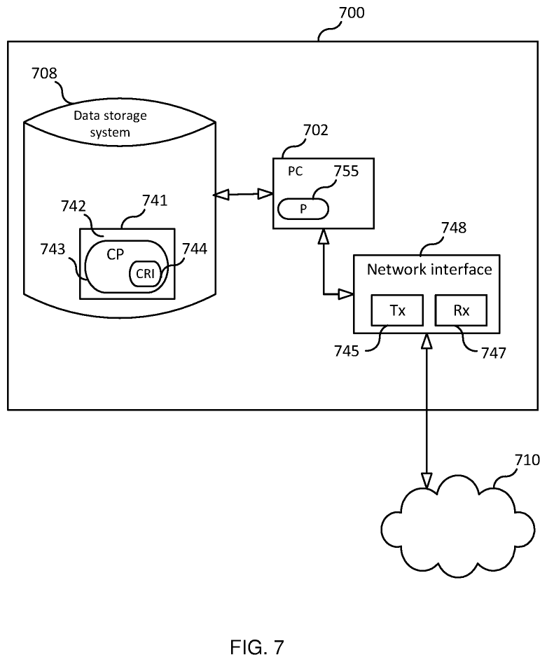

FIG. 7 is a block diagram of a computing device 700 according to some embodiments. In some embodiments, computing device 700 may comprise one or more of the components of a local user and/or a global user as described above. As shown in FIG. 7, the device may comprise: processing circuitry (PC) 702, which may include one or more processors (P) 755 (e.g., one or more general purpose microprocessors and/or one or more other processors, such as an application specific integrated circuit (ASIC), field-programmable gate arrays (FPGAs), and the like); communication circuitry 748, comprising a transmitter (Tx) 745 and a receiver (Rx) 747 for enabling the device to transmit data and receive data (e.g., wirelessly transmit/receive data); and a local storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes the apparatus to perform steps described herein (e.g., steps described herein with reference to the flow charts). In other embodiments, the apparatus may be configured to perform steps described herein without the need for code. That is, for example, PC 802 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### ABBREVIATIONS

NLG Natural Language Generation
NLP Natural Language Processing
FSO Field Service Operation Professional
BERT Bidirectional Encoder Representations from Transformers

### REFERENCES

[1] Thorsten Wittkopp and Alexander Acker. (2021). Decentralized Federated Learning preserves model and data privacy, February 2021.
[2] Collins, A., Brown, J. S., & Holum, A. (1991). Cognitive Apprenticeship: Making Thinking Visible. American Educator, 6,38-46.
[3] Novak, J. D., & Gowin, D. B. (1984). Learning How To Learn. Cambridge: Cambridge University Press.
[4] Yuchen Lin, Bill, Chaoyang He, Zihang Zeng, Hulin Wang, Yufen Huang,
[5] Mahdi Soltanolkotabi, Xiang Ren, and Salman Avestimehr. “FedNLP: A Research Platform for Federated Learning in Natural Language Processing.” arXiv e-prints(2021): arXiv-2104.
[5] Chen, Mingyang, Wen Zhang, Zonggang Yuan, Yantao Jia, and Huajun Chen. “FedE: Embedding Knowledge Graphs in Federated Setting.” arXiv preprint arXiv:2010.12882 (2020).
[6] K. Wei et al., “Federated Learning With Differential Privacy: Algorithms and Performance Analysis,” in IEEE Transactions on Information Forensics and Security, vol. 15, pp. 3454-3469, 2020, doi: 10.1109/TIFS.2020.2988575.

1. A computer-implemented method of searching a plurality of data sources, the method comprising:
obtaining, from a first local Machine Learning (ML) model, a first set of word embeddings corresponding to a first relationship mapping of a first plurality of documents from a first data source;
obtaining, from a second local ML model, a second set of word embeddings corresponding to a second relationship mapping of a second plurality of documents from a second data source;
generating a first latent space representation by processing the first set of word embeddings using a first artificial neural network (ANN) trained with the first local ML model, wherein the first latent space representation comprises a plurality of first contexts associated with the first set of word embeddings;
generating a second latent space representation by processing the second set of word embeddings using a second ANN trained with the second local ML model, wherein the second latent space representation comprises a plurality of second contexts associated with the second set of word embeddings;
correlating the first set of word embeddings and the second set of word embeddings based on the plurality of first contexts and the plurality of second contexts;
aggregating, based on the correlating, the first set of word embeddings and the second set of word embeddings into a global Machine Learning (ML) model of word embeddings;
obtaining a search query, the search query comprising a context and one or more word embeddings;
generating a response to the query using the global ML model; and
outputting the generated response to a user.

2. The method of claim 1, wherein the first data source has a location that is different than a location of the second data source.

3. The method of claim 1, wherein the first relationship mapping comprises a first plurality of tuples and the second relationship mapping comprises a second plurality of tuples, wherein each tuple comprises a first entity, a second entity, and a relationship between the first entity and the second entity.

4. The method of claim 3, wherein
the first local ML model predicts a relationship between a first entity and a second entity in the first plurality of tuples, and
the second local ML model predicts a relationship between a first entity and a second entity in the second plurality of tuples.

5. The method of claim 4, wherein the first local ML model and the second local ML model comprise continuous bag of words (CBOW) models.

6. The method of claim 1, wherein the ANN is a Bidirectional Encoder Representation from Transformers (BERT) language model.

7. The method of claim 1, wherein the correlating further comprises:
selecting a first word embedding in the first set of word embeddings having a first corresponding context;
selecting a second word embedding in the second set of word embeddings having a second corresponding context;
determining that the first word embedding is the same or substantially the same as the second word embedding and that the first corresponding context is the same or substantially the same as the second corresponding context; and
in response to the determination that the first word embedding is the same or substantially the same as the second word embedding and that the first corresponding context is the same or substantially the same as a the second corresponding context, averaging the first word embedding and the second word embedding in the global ML model.

8. The method of claim 1, wherein the correlating further comprises:
selecting a third word embedding in the first set of word embeddings having a third corresponding context;
selecting a fourth word embedding in the second set of word embeddings having a fourth corresponding context;
determining that the third word embedding is the same or substantially the same as the fourth word embedding and that the third corresponding context is not the same or substantially the same as the third corresponding context; and
in response to the determination that the third word embedding is the same or substantially the same as the fourth word embedding and that the third corresponding context is not the same or substantially the same as a the third corresponding context, maintaining the first word embedding and the second word embedding in the global ML model.

9. The method of claim 1, further comprising:
obtaining a public dataset, the public dataset comprising a plurality of public search queries and corresponding public outputs; and
for each public search query in the public dataset, determining a conditional probability of each word in the global ML model appearing in the corresponding public output;
determining, for each search query in the public dataset, a corresponding context using the global ML model; and
updating the conditional probabilities based on the determined corresponding context.

10. The method of claim 1, further comprising:
identifying the context of the obtained search query using the global ML model; and
predicting, based on the identified context and the global ML model, one or more words to include in the response to the query.

11. The method of claim 10, further comprising:
arranging the one or more words using a natural language generation (NLG) model, wherein the generated response comprises the arrangement of the one or more words.

12. The method of claim 1, further comprising:
marking a word embedding in the global ML model as comprising an anonymized word, wherein the marked word embedding corresponds to an anonymized word present in one or more of the first plurality of documents.

13. The method of claim 12, further comprising:
determining that the generated response comprises the anonymized word;
in response to the determining, identifying a document in the first plurality of documents having a frequency of the anonymized word that is greater than a frequency of the anonymized word in any other document in the first plurality of documents; and
providing the identified document to the user.

14. A computing device comprising processing circuitry and a memory coupled to the processing circuitry, wherein the device is adapted to perform the method of
obtaining, from a first local Machine Learning (ML) model, a first set of word embeddings corresponding to a first relationship mapping of a first plurality of documents from a first data source;
obtaining, from a second local ML model, a second set of word embeddings corresponding to a second relationship mapping of a second plurality of documents from a second data source;
generating a first latent space representation by processing the first set of word embeddings using a first artificial neural network (ANN) trained with the first local ML model, wherein the first latent space representation comprises a plurality of first contexts associated with the first set of word embeddings;
generating a second latent space representation by processing the second set of word embeddings using a second ANN trained with the second local ML model, wherein the second latent space representation comprises a plurality of second contexts associated with the second set of word embeddings;
correlating the first set of word embeddings and the second set of word embeddings based on the plurality of first contexts and the plurality of second contexts;
aggregating, based on the correlating, the first set of word embeddings and the second set of word embeddings into a global Machine Learning (ML) model of word embeddings;
obtaining a search query, the search query comprising a context and one or more word embeddings;
generating a response to the query using the global ML model; and
outputting the generated response to a user.

15. The computing device of claim 14, wherein the first data source has a location that is different than a location of the second data source.

16. A computer program product comprising a non-transitory computer readable medium storing a computer program comprising instructions which when executed by processing circuitry of a computing device causes the device to perform the method of claim 1.

17. A computer program product comprising a non-transitory computer readable medium storing a computer program comprising instructions which when executed by processing circuitry of a computing device causes the device to perform the method of claim 2.
